(19) United States
(12) Patent Application Publication
(10) Pub. No.: US 2026/0259312 A1
(43) Pub. Date: Sep. 3, 2026

(54) RADAR SENSOR NETWORK AND METHOD FOR DETERMINING THE RELATIVE VELOCITY OF A RADAR TARGET

(71) Applicant: Robert Bosch GmbH, Stuttgart (DE)

(72) Inventor: Benedikt Loesch, Stuttgart (DE)

(21) Appl. No.: 19/163,871

(22) PCT Filed: Apr. 8, 2024
(86) PCT No.: PCT/EP2024/059426

§ 371 Date: Sep. 10, 2025

(30) Foreign Application Priority Data
Jun. 23, 2023 (DE) 10 2023 205 898.7

(51) Int. Cl. G01S 13/58

(52) U.S. Cl. CPC G01S 13/583

(57) ABSTRACT

A radar sensor network and method for determining the relative velocity of a radar target. Phase-modulated transmission signals are transmitted using transmission antenna elements of each of a plurality of radar sensors. A ramp-like frequency-modulated transmission signal of a respective radar sensor has temporally nested sequences of ramps which follow each other in a time-offset manner with a predefined time interval within the respective sequence. A phase of the transmission signal is phase-modulated with a code for each transmission antenna element of a radar sensor. A measurement cycle of the radar sensors includes sections which follow one another temporally and which are each allocated to one of the radar sensors and include one or a plurality of ramps of the transmission signal exclusively from the radar sensor allocated to the section. An estimated value for the relative velocity of the radar target is determined from the received response signals.

### FIELD

The present invention relates to a radar sensor network and a method for determining a relative velocity of a radar target. The radar sensor network can in particular be a radar sensor network for motor vehicles. The radar sensors of the radar sensor network can in particular be configured for an FMCW (frequency modulated continuous wave) measuring method with linear frequency ramps and an evaluation of the received signals by means of discrete Fourier transformation, in particular an FFT (Fast Fourier Transformation).

### BACKGROUND INFORMATION

Radar sensors are used to implement comfort functions such as adaptive cruise control and safety functions such as emergency braking assist. The main advantage of such sensors is that they measure physical variables directly and do not interpret images, such as from a video camera. The radar sensors emit radiofrequency radar beams via an antenna structure and receive the beams reflected from objects. The detected objects can be stationary or moving. With the aid of the received radar beams, the distance and direction (angle) to the object can be calculated. In addition, the relative velocity of an object to the radar sensor can also be calculated. Typical radar sensors operate in a frequency range between 76 and 81 GHz.

The so-called chirp sequence method is a well-known method for radar modulation. In this process, many fast frequency ramps, so-called chirps, are transmitted. In order to increase the accuracy and angular resolution, a plurality of transmission antennas are often used to achieve an enlarged virtual aperture using the MIMO (Multiple-Input Multiple-Output) principle. The transmission signals must be separated during reception. A simple method for this is a time multiplexing method, in which the temporal interval between chirps transmitted by the same transmission antenna increases by a factor of N=number of transmission antennas. As a result, the clear measurement range for the relative velocity is also reduced by a factor of N.

U.S. Patent Application Publication No. US 2019/0353770 A1 and Germany Patent Application No. DE 10 2017 200 317 A1 describe a radar sensor and a method for determining a relative velocity of a radar target. An estimation of the velocity of objects is carried out by means of a radar sensor with a plurality of transmission antennas. A plurality of nested sequences of frequency ramps are transmitted by means of a plurality of transmission antennas. Here, each transmission antenna is individually phase-coded by means of a harmonic code. For estimating the velocity of the object, the ambiguities due to code multiplexing are resolved.

In cooperative radar sensor networks, a distinction is made between systems with coherent distribution of the RF oscillator signal and those without distribution of the RF oscillator signal. Systems with distribution of the RF oscillator signal show significantly better phase noise behavior; however, the distribution of the oscillator signal is associated with considerable effort, and so a solution without distribution of the oscillator signal is advantageous for practical implementation.

In a cooperative radar sensor network without distribution of the RF oscillator signal, an evaluation of response signals can comprise an evaluation of response signals received in one radar sensor to transmission signals from another of the radar sensors in the radar network. This can be carried out by calibration or compensation between non-coherent radar sensors. The evaluation can be carried out, for example, according to techniques described in the two documents mentioned below:
M. Gottinger, F. Kirsch, P. Gulden and M. Vossiek, “Coherent Full-Duplex Double-Sided Two-Way Ranging and Velocity Measurement Between Separate Incoherent Radio Units,” IEEE Transactions on Microwave Theory and Techniques, vol. 67, no. 5, pp. 2045-2061, May 2019, doi: 10.1109/TMTT.2019.2902553;
A. Durr, B. Schweizer, J. Bechter and C. Waldschmidt, “Phase Noise Mitigation for Multistatic FMCW Radar Sensor Networks Using Carrier Transmission,” IEEE Microwave and Wireless Components Letters, vol. 28, no. 12, pp. 1143-1145, December 2018, doi: 10.1109/LMWC.2018.2878983.

If the code multiplexing method of U.S. Patent Application No. US 2019/0353770 A1 and Germany Patent Application No. DE 10 2017 200 317 A1 were used for multiplexing a plurality of sensors in a cooperative sensor network without a common oscillator signal, as a rule, the uncorrelated phase noise of the various local oscillators would cause a significant increase in the noise level in the received signals of all sensors, so that the sensitivity and dynamics of the radar sensor network would be severely limited. The monostatic signals (transmitting and receiving on the same radar sensor with its own oscillator signal) would also exhibit this degradation.

### SUMMARY

An object of the present invention is to provide a modulation method for a radar sensor network which enables a clear velocity measurement in the individual sensor and simultaneously achieves good phase noise behavior in the monostatic signal response.

The object may be achieved according to the present invention by a method for determining a relative velocity of a radar target.

According to an example embodiment of the present invention, the method comprises the following steps:
Transmitting phase-modulated transmission signals by means of a plurality of transmission antenna elements of each of a plurality of radar sensors, wherein a ramp-like frequency-modulated transmission signal of a respective one of the radar sensors is generated which has a plurality of temporally nested sequences of ramps, wherein the ramps within the particular sequence follow one another in a time-offset manner with a predetermined time interval, wherein a phase of the generated ramp-like frequency-modulated transmission signal is, for each transmission antenna element of a radar sensor, phase-modulated with a code, and wherein a measurement cycle of the plurality of radar sensors comprises sections which follow on from one another temporally, which in each case are allocated to one of the radar sensors and comprise one ramp or a plurality of ramps of the transmission signal exclusively from the radar sensor allocated to the section;
Receiving response signals to the transmitted phase-modulated transmission signals;
Calculating a two-dimensional spectrum for each sequence of the transmission signal of a particular radar sensor by a two-dimensional Fourier transformation of baseband signals of the received response signals, wherein the transformation is carried out in a first dimension per ramp and in a second dimension via a ramp index of the sequence of ramps;
Ascertaining values for relative velocities of a radar target that are periodic with a predetermined velocity period, based on a peak in one of the calculated two-dimensional spectra;
Determining an estimated value for the relative velocity of the radar target based on matches in phase relationship between values of the two-dimensional spectra at identical positions with expected phase relationships for a plurality of the ascertained values of relative velocities.

The sequences of ramps are also referred to as ramp sequences below. Unless otherwise stated, the term sensor refers to a radar sensor. The ramps are also referred to as chirps.

In this way, a clear velocity measurement is made possible based on the phase-modulated transmission signals transmitted by the transmission antenna elements of a particular radar sensor and the response signals received (for example, in particular by means of at least one reception antenna element of the same radar sensor), without this velocity measurement being impaired by simultaneously transmitted transmission signals from another of the radar sensors. This is because, at any given transmission time, only one of the radar sensors transmits the ramp-like frequency-modulated transmission signal.

The present invention thus includes a modulation method that operates each individual sensor with the aid of a modulation method, in particular a JSFMCW modulation method (Joint Sampling FMCW), with code multiplexing (e.g., DDM, Doppler division multiplexing) and operates the various individual sensors in time multiplexing. Since only one sensor transmits radar beams at any given fixed point in time, the phase noise behavior of the individual sensor is only determined by the phase noise of the local oscillator or the transmission signal processing of the individual sensor and thus allows high sensitivity and signal dynamics in the monostatic response (i.e., the same radar sensor transmits and receives). By using the JSFMCW method with DDM, high sensitivity is achieved in the individual sensor (all transmitters of a radar sensor are active simultaneously) and simultaneously a clear velocity measurement is made possible without requiring the existence of bistatic paths (i.e., paths between different radar sensors).

The method of the present invention makes it possible to extend the MIMO principle to a network of a plurality of cooperative radar sensors, thus further increasing performance. The fundamental challenges of the clear measurement range in the relative velocity and the multiplexing of the transmitters remain manageable.

The terms “monostatic” and “bistatic” are used herein, on the one hand, in relation to an antenna system of a radar sensor, wherein in a bistatic antenna system the transmission antenna elements are different from the reception antenna elements, and wherein in a monostatic antenna concept of a radar sensor the same antenna elements are used for transmitting and receiving. On the other hand, the terms “monostatic” and “bistatic” are used herein to refer to a received radar signal of one of the plurality of radar sensors, wherein the term “monostatic” is used to mean that a received radar signal is based on a transmission signal transmitted by the same radar sensor, and the term “bistatic” is used to mean that a received radar signal is based on a transmission signal transmitted by another of the plurality of radar sensors.

According to an example embodiment of the present invention, the transmission and reception antenna elements of the radar sensors can in each case have the same structure. For example, they can in each case consist of a patch antenna array.

According to an example embodiment of the present invention, the reception of response signals to the transmitted phase-modulated transmission signals can comprise: wherein at least response signals to the phase-modulated transmission signal transmitted by the transmission antenna elements of a particular radar sensor are received by means of at least one reception antenna element of the same radar sensor. That is, at least monostatic response signals are received.

A measurement cycle of the plurality of radar sensors comprises sections which follow on from one another temporally, which in each case are allocated to one of the radar sensors and comprise one or more ramps of the transmission signal from the radar sensor allocated to the section. In particular, the sections can in each case comprise one or more ramps of the transmission signal exclusively from the radar sensor allocated to the section. Thus, at any given point in time, only the transmitted, phase-modulated, ramp-like frequency-modulated transmission signal of at most one of the plurality of radar sensors goes through a ramp.

Thus, the respective radar sensors transmit in a time-offset manner according to a time multiplexing method. In other words, the individual ramps of the sequences of a respective one of the radar sensors do not overlap in time with the ramps of the sequences of the respective other one of radar sensors, or they are arranged in a time multiplexing method of the radar sensors so as not to overlap in time with the ramps of the sequences of the respective other one of radar sensors. In particular, when a ramp of the transmission signal of a particular radar sensor is run through, it is only the radar sensor in question which transmits. Thus, at any given point in time, a transmission signal of only one of the respective radar sensors (i.e., transmission signals of the transmission antenna elements of only one of the respective radar sensors) is transmitted in a ramp-like frequency-modulated manner. The phase-modulated transmission signals of the radar sensor are transmitted simultaneously by means of the plurality of transmission antenna elements of the radar sensor in question. In a particular radar sensor, the transmission signal is thus transmitted simultaneously (synchronously) by a plurality of transmission antenna elements, with the respective coding modulated by phase modulation. A different code is used for each transmission antenna element transmitting simultaneously. The ramps of the ramp sequences of the transmission signals of the transmission antenna elements of a respective one of the plurality of radar sensors are arranged in temporal gaps between the ramps of the ramp sequences of the transmission signals of the transmission antenna elements of the respective other one of the plurality of radar sensors; they are arranged according to a time multiplexing scheme. In particular, the transmission of phase-modulated transmission signals can comprise: wherein the respective radar sensors transmit the phase-modulated, ramp-like frequency-modulated transmission signal according to a time multiplexing method of the plurality of radar sensors.

According to an example embodiment of the present invention, the method can comprise the following step: allocating a response signal to one of the plurality of transmission antenna elements. This can be carried out in particular based on the code of the transmission signal of the transmission antenna element. In order to be able to allocate the response signals or the transmission signals to a transmission antenna element, noise-like or harmonic codes are possible, for example. Based on the allocation, an angle estimation of the detected radar target can be carried out.

In example embodiments of the present invention, the code is a harmonic code. In this connection, harmonic means that the phase modulation describes a discrete, harmonic oscillation. A harmonic code is thus understood here as follows: A phase of the generated ramp-like frequency-modulated transmission signal is phase-modulated, for each transmission antenna element of a radar sensor, with a (complex) harmonic code, wherein the harmonic code describes a discrete, harmonic oscillation. Possible harmonic codes are, for example, harmonic sequences such as 1, 1, 1, . . . ; 1, −1, 1, −1, . . . ; or 1, i, −1, −i, 1, . . . or other harmonic frequencies. Phase modulation by means of harmonic codes leads to additional ambiguities for the velocities to be estimated. These ambiguities can also be resolved.

The transmission signal of a radar sensor can, for example, be generated from an RF oscillator signal. The transmission signals from the plurality of radar sensors can be coherent or non-coherent with one another. In example embodiments of the present invention, the transmission signal and/or an RF oscillator signal of the particular radar sensor is generated by the particular radar sensor. For example, a reference signal can be generated and distributed to at least one or more of the plurality of radar sensors, wherein the at least one or more of the plurality of radar sensors generate the particular transmission signal based on the reference signal. The reference signal can be, for example, a clock signal or an RF oscillator signal. The latter enables coherent transmission signals of the radar sensors. In other embodiments, the transmission signals of the radar sensors are generated by an RF oscillator and distributed to at least one of the plurality of radar sensors. This enables coherent transmission signals of the radar sensors.

In particular, according to an example embodiment of the present invention, the calculation of a two-dimensional spectrum for each sequence of the transmission signal of a particular radar sensor can comprise: calculating, for a particular reception channel of a particular radar sensor, a two-dimensional spectrum for each sequence of the transmission signal of the particular radar sensor. That is, for each reception channel and/or each reception antenna element of a radar sensor, a two-dimensional spectrum is calculated for each sequence of the transmission signal of the radar sensor. The received response signals thus comprise monostatically received radar signals. The particular reception channel is allocated to a particular reception antenna element.

In the two-dimensional Fourier transformation of baseband signals of the received response signals, the transformation is carried out in a first dimension per ramp and in a second dimension via a ramp index of the sequence of ramps. In other words, the transformation is carried out ramp by ramp in a first dimension and in a second dimension via a ramp index that counts the ramps within the sequence.

According to an example embodiment of the present invention, values for relative velocities of a radar target which are periodic with a predetermined velocity period are ascertained, based on a peak in one of the calculated two-dimensional spectra. In other words, the method comprises: ascertaining values for relative velocities of a radar target that are periodic with a predetermined velocity period starting from a peak in one of the calculated two-dimensional spectra.

According to the example embodiment of the present invention, the method comprises: determining an estimated value of the relative velocity of the radar target based on matches in phase relationship between values of the two-dimensional spectra at identical positions with expected phase relationships for a plurality of the ascertained values of relative velocities. For example, the method can comprise: identifying matches in phase relationship between values of the two-dimensional spectra at identical positions with expected phase relationships for a plurality of the ascertained values of relative velocities, and selecting an estimated value for the relative velocity of the radar target based on the identified match of the phase relationship. In particular, the determination of an estimated value of the relative velocity of the radar target can comprise: identifying matches in phase relationship between values of the two-dimensional spectra at identical positions with expected phase relationships for a plurality of the ascertained values of relative velocities, and selecting an estimated value for the relative velocity of the radar target based on the identified match of the phase relationship.

In example embodiments of the present invention, the plurality of radar sensors each comprise a circuit board (printed circuit board), wherein the circuit boards of the respective radar sensors are separated from one another. In embodiments, the plurality of radar sensors are arranged separately from one another at different positions on the vehicle. In particular, the plurality of radar sensors have overlapping or identical fields of view.

According to an example embodiment of the present invention, the ramp sequences of the individual sensors can have identical parameters (duration and frequency deviation of the chirps, number of chirps, (if applicable, time-variable) center frequency, start times of the individual chirps), but this is not a prerequisite for the method. In example embodiments of the present invention, within a sequence of ramps, the ramps have an identical ramp slope, an identical difference in ramp center frequencies, an identical ramp center frequency, an identical ramp duration and/or an identical ramp frequency deviation. In example embodiments of the present invention, ramps with an identical ramp index in the ramp sequences of the radar sensors in each case have an identical ramp slope, an identical ramp center frequency, an identical ramp duration, an identical ramp frequency deviation, and/or an identical time offset to a ramp with a ramp index which is one lower in the same ramp sequence.

In example embodiments of the present invention, the transmission signals of the plurality of radar sensors have different time offsets between their ramp sequences (more precisely: between ramps which follow on from one another, each of which belongs to a particular ramp sequence, or between the start times of their ramp sequences); i.e., at least one or more of the time offsets between the ramp sequences of one radar sensor differs/differ from each of the time offsets between the successive start times of the ramp sequences of at least one of the other radar sensors, or from each of the time offsets between the successive start times of the ramp sequences of each other of the radar sensors.

In example embodiments of the present invention, the transmission signals of the plurality of radar sensors have different time intervals with which the ramps within the particular ramp sequence follow one another with a time offset, and/or different ramp durations (durations of the chirps).

In example embodiments of the present invention, the ramp sequences of a particular radar sensor have equidistant time offsets from one another. In other words, ramps with in each case the same ramp index of the ramp sequences of a particular radar sensor have equidistant time offsets from one another. That is, their ramp start times are arranged equidistantly in time. In other embodiments, the ramp sequences of a particular radar sensor in each case have non-equidistant time offsets from one another in pairs. In other words, ramps with the same ramp index of the ramp sequences of a particular radar sensor in each case have non-equidistant time offsets from one another in pairs. That is, their ramp start times are arranged non-equidistantly in time.

In example embodiments of the present invention, the transmission signal of the particular radar sensor comprises or forms a sequence of ramp groups arranged temporally one after the other, wherein each ramp group comprises (or consists of) a ramp from each of the sequences of ramps of the transmission signal of the radar sensor. These can in particular be ramps with in each case the same ramp index. Thus, the ramp groups of a sequence of ramp groups follow one another temporally. This following can be seamless and/or spaced apart.

In example embodiments of the present invention, a measurement cycle of the plurality of radar sensors comprises blocks which follow on from one another temporally, wherein each block comprises a ramp group from each of the radar sensors. In preferred embodiments, each block comprises exactly one ramp group from each of the radar sensors.

For example, the measurement cycle of the plurality of radar sensors can be divided into blocks.

In particular, a measurement cycle of the plurality of radar sensors can comprise blocks which follow on from one another temporally, wherein each block comprises (exactly) one ramp group from each of the radar sensors, wherein the ramps of one ramp group of the block are temporally nested with the ramps of each of the other ramp groups of the block.

In preferred embodiments of the present invention, in each block, the ramps of one ramp group of the block are temporally nested with the ramps of each of the other ramp groups of the block. Such a radar modulation scheme is also referred to as radar modulation scheme #1. Thus, each ramp group of a block is distributed over at least two sections that are allocated to the radar sensor of the ramp group. Thus, the ramps of a ramp group of one radar sensor are nested with ramps of a ramp group of each of the other radar sensors. More precisely, the ramps of a ramp group of the ramp group sequence of the transmission signal of a particular radar sensor are (temporally) nested with the ramps of a ramp group of the ramp group sequence of the transmission signal of each of the other radar sensors.

In particular, between in each case two ramps which follow on from one another of a particular sequence of ramps of a transmission signal of one radar sensor, at least one ramp of each of the sequences of ramps of the transmission signals of the other radar sensors can be arranged, i.e., run through.

In radar modulation scheme #1, the plurality of radar sensors are operated in a nested time multiplexing method, as a result of which the time offset between the radar sensors is kept as small as possible. In each case, a plurality of transmission antenna elements are active at the same time by means of code multiplexing, in particular Doppler division multiplexing (DDM).

The time offset of the ramp sequences of the individual sensors can be selected to be equidistant or non-equidistant, depending on the application and further signal processing. Where applicable, an equidistant time offset simplifies implementation and optimization. The exact design of the modulation scheme can be optimized with regard to velocity clarity, taking into account the properties of the individual ramp sequences. For example, it is possible to vary the time intervals from chirp to chirp within a sequence.

In example embodiments of the present invention, the method comprises: performing digital beamforming for a radar target over transmission channels allocated to the transmission antenna elements and/or over reception channels allocated to reception antenna elements of at least two of the plurality of radar sensors, wherein phase differences between the radar sensors which are dependent on the relative velocity of the radar target are taken into account when performing the digital beamforming. In particular, a particular phase difference between two of the radar sensors for a radar target can be ascertained based on at least one (in particular the determined) estimated value of the relative velocity of the radar target and based on a time offset (within a block) between the ramp groups of the two radar sensors. In particular, the digital beamforming can be performed over a plurality of (e.g., all) transmission channels and/or a plurality of (e.g., all) reception channels of the at least two radar sensors. Beamforming over a plurality of (e.g., all) transmission channels is referred to as transmit-side beamforming. Beamforming over a plurality of (e.g., all) reception channels is referred to as receive-side beamforming. Beamforming is also referred to as MIMO (Multiple-Input Multiple-Output) beamforming. The phase difference corresponds to a phase change of the received radar signals due to a relative movement of the radar target during the time offset between the ramp groups of the different radar sensors. Taking the particular phase difference into account makes it possible to jointly and coherently evaluate two-dimensional spectra originating from different radar sensors. Performing digital beamforming can in particular comprise the phase-correct summation of the calculated two-dimensional spectra or parts of the calculated two-dimensional spectra corresponding to the radar target.

According to an example embodiment of the present invention, the digital beamforming can be performed for received monostatic radar signals (response signals) or for received monostatic and bistatic radar signals (response signals). When processing monostatic response signals from different radar sensors, the phase difference between the radar sensors in question is taken into account. When processing bistatic response signals received by one radar sensor to phase-modulated transmission signals transmitted by another radar sensor, the phase difference between the radar sensors in question is taken into account.

By means of the clear velocity measurement of the individual sensors, a velocity-dependent phase correction (the phase difference) can be ascertained in order to compensate for the time offset between the bistatic and/or monostatic signals and thus enable joint and coherent processing of the signals from the plurality of sensors.

The clear velocity measurement of the individual sensors also allows for partial processing on the individual sensors: for example, MIMO beamforming (transmit-side and receive-side beamforming) can already be carried out on the individual sensors. The determination of the clear velocity and beamforming can be carried out prior to or after the detection of a radar target.

The described processing of the present invention can be carried out completely on a central evaluation unit, e.g., a central control unit, or in partial aspects on the individual sensors, e.g. on evaluation units of the individual radar sensors.

In example embodiments of the present invention, the method comprises: ascertaining an angle estimation for the radar target. Ascertaining the angle estimation for the radar target can, for example, comprise performing the digital beamforming for the radar target.

In example embodiments of the present invention, performing the digital beamforming for a radar target comprises a first sub-step in which digital beamforming for the radar target is performed over transmission channels allocated to the transmission antenna elements and/or over reception channels allocated to the reception antenna elements of a respective one of the at least two of the plurality of radar sensors, and a second sub-step in which the digital beamformings of the respective at least two radar sensors are combined, taking into account the phase differences between the radar sensors which are dependent on the relative velocity of the radar target.

In example embodiments of the present invention, receiving response signals to the transmitted phase-modulated transmission signals comprises: wherein at least response signals to the phase-modulated transmission signal transmitted by the transmission antenna elements of a particular radar sensor are received by means of at least one reception antenna element of the same radar sensor and response signals are received by means of at least one reception antenna element of another one of the plurality of radar sensors. That is, monostatic and bistatic response signals are received. The evaluation of the response signals can thus comprise an evaluation of response signals received in one radar sensor to transmission signals from another of the radar sensors in the radar network.

If required (e.g., too high phase noise in the bistatic response), the evaluation of the bistatic signals can alternatively be omitted and only the monostatic signals of the individual sensors are evaluated. This allows a fallback position having to change the modulation method.

In one example embodiment of the present invention, the steps of calculating a two-dimensional spectrum, ascertaining values for relative velocities of a radar target, determining an estimated value for the relative velocity of the radar target, and, if applicable, performing digital beamforming and/or ascertaining an angle estimation are performed at least for monostatic response signals of a radar sensor in question, wherein the steps are optionally also performed for bistatic response signals of a radar sensor in question. The method can comprise deciding on the performance of the steps also for bistatic response signals according to a (peak) signal-to-noise ratio of the bistatic response signals and/or according to a noise level of the bistatic response signals.

In further preferred example embodiments of the present invention, a measurement cycle of the plurality of radar sensors comprises sub-cycles which follow on from one another temporally, wherein each sub-cycle is allocated to one of the radar sensors and comprises the ramp groups of the allocated radar sensor. In particular, each sub-cycle can be allocated to one of the radar sensors and can comprise the ramp groups exclusively of the allocated radar sensor. Such a radar modulation scheme is also referred to as radar modulation scheme #2. In particular, for example, the sequences of the ramp groups of the radar sensors can follow one another temporally. That is: the sequence of ramp groups of a first radar sensor is followed by the sequence of ramp groups of a next radar sensor. Thus, a sub-cycle allocated to a radar sensor corresponds to a section allocated to that radar sensor.

For example, a measurement cycle of the plurality of radar sensors (a cycle of the transmission signals of the plurality of radar sensors) can comprise respective sub-cycles in which in each case only one of the respective radar sensors transmits, wherein the sub-cycles follow one another, and wherein, in a particular sub-cycle, only the temporally nested sequences of ramps of the radar sensor in question are run through.

In radar modulation scheme #2, the plurality of radar sensors are operated sequentially in a time multiplexing method, in which only one of the radar sensors transmits in each sub-cycle. In contrast to radar modulation scheme #1, radar modulation scheme #2 does not involve any temporal nesting of the transmission operation of the sensors. Instead, the individual sensors transmit sequentially, and all sensors preferably receive continuously.

When individual sensors transmit sequentially, the accuracy of the velocity measurement of the individual sensor may not be sufficient in order to enable coherent processing of the transmission signals across sensors. If the accuracy is sufficient, the evaluation can be carried out as described above. Otherwise, a separate evaluation of the “sub-cycles” is recommended, wherein the transmission signals of the particular active sensor and the reception signals (RX) of all sensors can be evaluated. The sequential transmission operation of the individual sensors results in an update rate of the detected targets that is increased by the number of sensors results, since processing takes place in each “sub-cycle.”

When evaluating the bistatic response signals, different virtual antenna arrangements with different ambiguity properties in the angle estimation are obtained due to the different activations of the transmitters (TX) in the “sub-cycles.”

According to an example embodiment of the present invention, as an alternative to the separate processing of the “sub-cycles” and the resulting increased update rate, a non-coherent averaging of the results of the sub-cycles can also be advantageous. The non-coherent averaging can be carried out at the spectral level prior to the detection of the targets or by averaging the angular spectra after target detection.

In example embodiments of the present invention, the method comprises: performing digital beamforming over transmission channels allocated to the transmission antenna elements and/or over reception channels allocated to reception antenna elements of a respective one of the plurality of radar sensors for a radar target and for a relevant sub-cycle.

The digital beamforming can be performed for received monostatic radar signals or for received monostatic and bistatic radar signals. When processing bistatic response signals received by a radar sensor to phase-modulated transmission signals transmitted by another radar sensor, different virtual antenna arrangements with different ambiguity properties in the angle estimation are obtained due to the different activations of the transmitters (TX) in the “sub-cycles.” These ambiguities can be resolved.

In example embodiments of the present invention, the method comprises: ascertaining an angle estimation for the radar target. Ascertaining the angle estimation for the radar target can, for example, comprise performing the digital beamforming for the radar target.

According to an example embodiment of the present invention, ascertaining an angle estimation can comprise: ascertaining a particular angle estimation, which is subject to ambiguity, for the radar target for monostatic and bistatic received response signals of a particular radar sensor; and ascertaining a clear angle estimation for the radar target based on the respective angle estimations for the radar target that are subject to ambiguity.

In example embodiments of the present invention, the digital beamforming is performed over transmission channels allocated to the transmission antenna elements and/or over reception channels allocated to the reception antenna elements of a respective one of at least two of the plurality of radar sensors for a radar target and for a particular relevant sub-cycle, wherein the method further comprises: combining the digital beamformings of the at least two radar sensors by non-coherently averaging the digital beamformings of the at least two radar sensors and relevant sub-cycles or by averaging angular spectra, obtained by the digital beamformings, of the radar target of the at least two radar sensors and relevant sub-cycles.

In example embodiments of the present invention, receiving response signals to the transmitted phase-modulated transmission signals comprises: wherein at least response signals to the phase-modulated transmission signal transmitted by the transmission antenna elements of a particular radar sensor are received by means of at least one reception antenna element of the same radar sensor and response signals are received by means of at least one reception antenna element of another one of the plurality of radar sensors. That is, monostatic and bistatic response signals are received.

According to one aspect of the present invention, the object may be achieved by a radar sensor network for determining a relative velocity of a radar target. According to an example embodiment of the present invention, the radar sensor network comprises a plurality of radar sensors and at least one evaluation unit,
wherein each of the plurality of radar sensors comprises the following:
a plurality of transmission antenna elements;
a signal generating device which is designed to generate a ramp-like frequency-modulated transmission signal and to provide it to the transmission antenna elements, wherein the transmission signal has a plurality of temporally nested sequences of ramps, wherein the ramps within the particular sequence follow one another with a predetermined time interval (Tr2r), wherein a phase of the generated ramp-like frequency-modulated transmission signal is, for each transmission antenna element of a radar sensor, phase-modulated with a code; and
at least one reception antenna element which is designed to receive a response signal to the transmitted phase-modulated transmission signals,
wherein the evaluation unit is designed to ascertain values for relative velocities of a radar target that are periodic with a predetermined velocity period, based on a peak in one of the two-dimensional spectra calculated for each sequence of the transmission signal of a particular radar sensor; and to determine an estimated value for the relative velocity of the radar target based on matches in phase relationship between values of the two-dimensional spectra at identical positions with expected phase relationships for a plurality of the ascertained values of relative velocities.

In preferred embodiments of the present invention, each of the plurality of radar sensors comprises a plurality of reception antenna elements. The plurality of reception antenna elements of a radar sensor are preferably spatially separated. The radar sensor thus forms a so-called MIMO (Multiple-Input Multiple-Output) system with a plurality of transmission and reception channels.

The radar sensor network is in particular a cooperative radar sensor network.

According to an example embodiment of the present invention, the evaluation unit can comprise a central evaluation unit and local evaluation units of the respective radar sensors. The local evaluation units can be part of the respective radar sensors. The evaluation unit can be designed in particular to carry out the described method of the present invention. The radar sensor network can comprise a control unit. The control unit can comprise the evaluation unit. The control unit can be designed to carry out the described method of the present invention. The control unit can comprise a central control unit and local control units of the respective radar sensors. The local control units can be part of the respective radar sensors. The local control units can in each case comprise the local evaluation unit.

In the following, exemplary embodiments are explained in more detail based on the figures.

### BRIEF DESCRIPTION OF THE DRAWINGS

FIG. 1 is a schematic representation of a cooperative radar sensor network with a plurality of radar sensors and a central control unit, according to an example embodiment of the present invention.

FIG. 2 is a schematic representation of a time-frequency diagram of transmission signals from a plurality of radar sensors according to one example embodiment of the present invention.

FIG. 3 is a schematic representation of a flow chart, such as that on which a method according to one example embodiment of the present invention is based.

FIG. 4 is a schematic representation of a time-frequency diagram of transmission signals from a plurality of radar sensors according to a further example embodiment of the present invention.

FIG. 5 is a schematic representation of virtual antenna arrangements according to a further example embodiment of the present invention.

FIG. 6 is a schematic representation of a flow chart according to a method according to a further example embodiment of the present invention.

### DETAILED DESCRIPTION OF EXAMPLE EMBODIMENTS

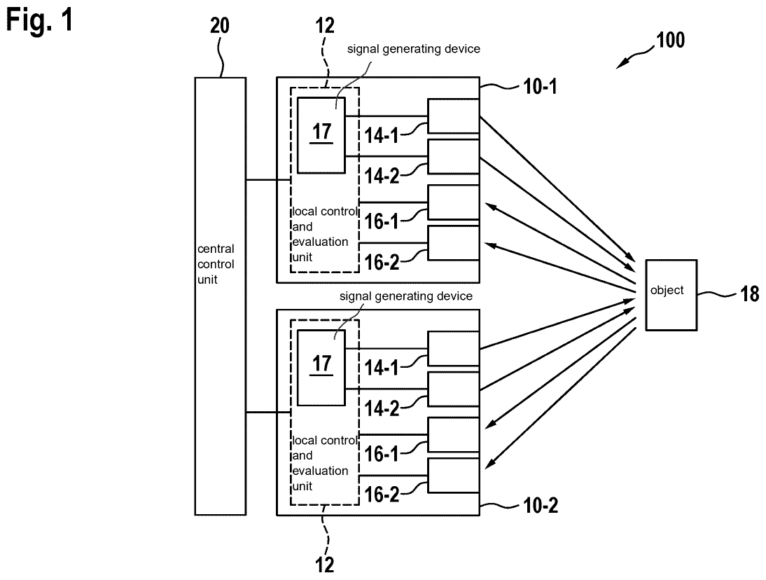

FIG. 1 is a schematic representation of a radar sensor network 100 with a plurality of FMCW radar sensors 10-1 and 10-2 and a central control unit 20. In practice, the number of radar sensors 10 can be larger. Each of the radar sensors 10-1, 10-2 comprises a local control and evaluation unit 12. Furthermore, each of the sensor sensors 10-1, 10-2 comprises two transmitter antenna elements 14-1, 14-2 and two reception antenna elements 16-1, 16-2. In practice, larger numbers of antenna elements are possible. The radar sensors 10-1, 10-2 are installed on the same side of a motor vehicle, for example at the front, and are configured to measure distances d, angles and relative velocities v of radar targets 18, for example of vehicles driving ahead or of obstacles.

In the example shown, the radar sensors 10-1, 10-2 in each case have a bistatic antenna system in which different antenna elements are used for transmitting and receiving. However, a monostatic antenna system can also be used, in which the particular radar sensor uses the same antenna elements for transmitting and receiving.

Each control and evaluation unit 12 comprises a signal generating device 17 that generates a transmission signal and is designed to individually modulate the phase of the supplied transmission signal for each transmission antenna element 14-1, 14-2. In the example, harmonic codes are used for the phase modulation of the transmission signals, wherein a different code is used for each transmission antenna element 14-1, 14-2. The phase-modulated transmission signals are supplied to the plurality of transmission antenna elements 14-1, 14-2 and transmitted by them. The radar signals which are transmitted and then reflected by an object 18 are received by the reception antenna elements 16-1, 16-2. The received signals are down-mixed to baseband signals and evaluated by the control and evaluation unit 12.

The frequency of the transmission signal can be modulated within a measurement cycle of a radar measurement with sequences of increasing or decreasing ramps. Examples of ramp-like frequency-modulated transmission signals are explained in more detail below.

The antenna elements 14-1, 14-2, 16-1, 16-2 can be arranged in different positions in a direction in which the radar sensor 10 is capable of angular resolution. For this purpose, in particular, a plurality of reception antenna elements 16-1, 16-2 are required, which are arranged at equal distances on a straight line (ULA; uniform linear array). The same also applies to the transmission antenna elements 14-1, 14-2, wherein the transmission and reception antenna elements 14-1, 14-2, 16-1, 16-2 do not necessarily have to be arranged on the same straight line. If the radar sensor 10 is to be used for measuring azimuth angles of objects, the straight lines on which the antenna elements are arranged run horizontally. In a sensor for measuring elevation angles, however, the antenna elements would be arranged on vertical lines. A two-dimensional antenna array is also possible, with which both azimuth angles and elevation angles can be measured.

The transmission antenna elements 14-1, 14-2 and reception antenna elements 16-1, 16-2 can in each case be constructed in the same way and, for example, comprise matching viewing regions. The transmission and reception antenna elements 14-1, 14-2, 16-1, 16-2 can, for example, in each case consist of a patch antenna array.

The central control and evaluation unit 20 in turn controls the control and evaluation units 12 of the radar sensors 10-1, 10-2 and takes over a part of the evaluation of the received radar signals that spans across the radar sensors.

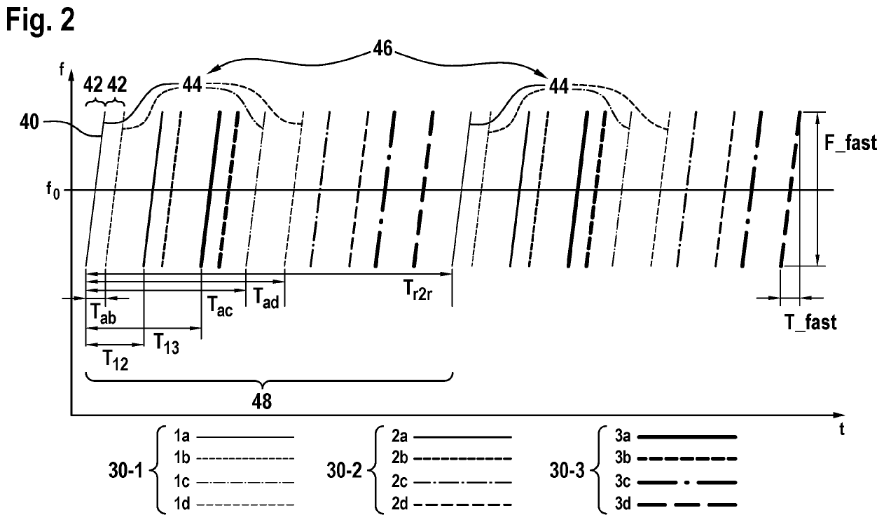

FIG. 2 shows a schematic diagram for the frequency f of transmission signals 30-1, 30-2, 30-3 of three radar sensors 10 of a cooperative radar sensor network 100, which can in principle correspond to the structure of FIG. 1, but comprises three FMCW radar sensors 10. The transmission signals 30-1, 30-2, 30-3 of the three radar sensors 10 are represented by different line thicknesses.

In each radar sensor 10, the corresponding ramp-like frequency-modulated transmission signal 30-1, 30-2 or 30-3 is generated. Each transmission signal 30-1, 30-2, 30-3 comprises a plurality of ramp sequences for each radar sensor 10, in the example shown four ramp sequences. The ramp sequences of the transmission signal 30-1 of the first radar sensor 10 are designated 1a, 1b, 1c, 1d in FIG. 1. Accordingly, the ramp sequences of the transmission signal 30-2 of the second radar sensor 10 are designated 2a, 2b, 2c, 2d, and the ramp sequences of the transmission signal 30-3 of the third radar sensor 10 are designated 3a, 3b, 3c, 3d. The respective ramp sequences are represented by different line types.

In FIG. 2, only the first two ramps 40 of each ramp sequence are shown. Each ramp 40 shown corresponds to a corresponding section 42 of the transmission signal 30-1, 30-2 or 30-3 in question. The transmission signal 30-1, 30-2 or 30-3 frequency-modulated according to the ramp 40 is, for each transmission antenna element 14 of the radar sensor in question, phase-modulated with a harmonic code and transmitted by the transmission antenna element 14, as explained with reference to FIG. 1. For example, the harmonic code is identical for all ramp sequences 1a, 1b, 1c, 1d within a ramp group 44, and a next code setting is selected for each next ramp group 44 (wherein each ramp group 44 comprises a ramp 40 from each of the ramp sequences 1a, 1b, 1c, 1d of the radar sensor 10).

FIG. 2 shows an example of a radar modulation scheme #1 for three radar sensors 10, with in each case a plurality of, e.g. four, transmission antenna elements 14 which are simultaneously active by means of Doppler division multiplexing (DDM) with harmonic codes. The three sensors 10 are operated in a nested time multiplexing method in order to keep the time offset between the sensors 10 as small as possible. The ramp-like frequency-modulated transmission signal 30-1, 30-2 or 30-3 of a respective one of the radar sensors 10 has a plurality of temporally nested ramp sequences. For example, the transmission signal 30-1 of the first radar sensor 10 has the four temporally nested ramp sequences 1a, 1b, 1c and 1d. Within the particular ramp sequence, the ramps follow on from one another in a time-offset manner with a predetermined time interval Tᵣ₂ᵣ. A measurement cycle of the radar sensors 10, of which only the first two ramps of each ramp sequence are shown in FIG. 2, comprises sections 42 which follow on from one another temporally, which in each case are allocated to one of the radar sensors 10 and thus to the corresponding transmission signal 30-1, 30-2 or 30-3 of the radar sensor 10 in question. Each section 42 comprises one ramp 40 or a plurality of ramps 40 of the transmission signal exclusively from the radar sensor 10 allocated to this section 42. Thus, the first two sections 42 identified in FIG. 2 comprise exclusively ramps 40 exclusively from the first radar sensor 10, wherein the ramps belong to its transmission signal 30-1.

For the particular transmission signal 30-1, 30-2, 30-3, the term ramp group refers to a group of those ramps of the ramp sequences of the transmission signal that have an identical ramp index. For example, the transmission signal 30-1 of the first radar sensor 10 comprises ramp groups 44, which in each case comprise a ramp 40 from the ramp sequences 1a, 1b, 1c and 1d. In radar modulation scheme #1, the transmission signal 30-1, 30-2, 30-3 of the particular radar sensor 10 thus comprises a sequence 46 of ramp groups 44 arranged temporally one after the other, wherein each ramp group 44 comprises a ramp 40 from each of the ramp sequences 1a, 1b, 1c, 1d of the radar sensor 10.

At the same time, the measurement cycle of the plurality of radar sensors 10 is divided into blocks 48 which follow on from one another temporally. Each block 48 comprises a ramp group 44 from each of the radar sensors 10, i.e., a ramp group from each of the transmission signals 30-1, 30-2, 30-3 of the radar sensors 10.

The blocks 48 follow on from one another in a time-offset manner with the time interval Tᵣ₂ᵣ. In each block 48, the ramps 40 of each ramp group 44 of the block 48 are temporally nested with the ramps 40 of each of the other ramp groups 44 of the block 48. If, for example, in FIG. 2 in the first block 48 one considers the ramp group 44 which comprises the ramps 40 with ramp index 1 of the first transmission signal 30-1, i.e. those ramps with ramp index 1 of the ramp sequences 1a, 1b, 1c and 1d, these ramps 40 are temporally nested with the ramps of the other ramp groups 44 of the block 48: The block 48 comprises a second ramp group 44 which in each case comprises the ramps with ramp index 1 of the ramp sequences 2a, 2b, 2c and 2d, and the block 48 comprises a third ramp group 44 which in each case comprises the ramps with ramp index 1 of the ramp sequences 3a, 3b, 3c and 3d.

In the example shown, in a block 48, the ramps 40 of the first ramp group 44 have a time offset T₁₂ to the ramps 40 of the second ramp group 44 and a time offset T₁₃ to the ramps 40 of the third ramp group 44. The relevant time offset T₁₂, T₁₃ is significantly smaller than the time interval Tᵣ₂ᵣ of the ramps within a particular ramp sequence. Pauses occur between some of the ramps of a particular ramp group 44. Furthermore, pauses occur between some ramps which follow on from one another of the different transmission signals 30-1, 30-2, 30-3.

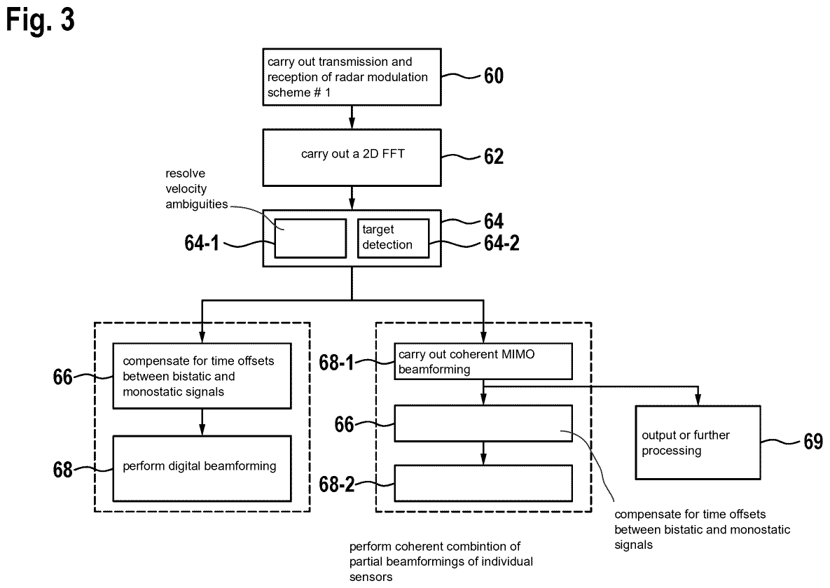

The further evaluation of the received radar signals corresponds to the flow chart in FIG. 3 of a method for determining a relative velocity of a radar target 18, which is explained below.

In a step 60, the transmission and reception of radar modulation scheme #1 is carried out as explained above. This comprises transmitting the phase-modulated transmission signals 30-1, 30-2, 30-3 and receiving response signals to the transmitted phase-modulated transmission signals.

In a step 62, a 2D FFT of the individual ramp sequences 1a, 1b, 1c, 1d, or 2a, 2b, 2c, 2d, or 3a, 3b, 3c, 3d is carried out for each individual sensor. For each ramp sequence of the transmission signal 30-1, 30-2, 30-3 of the particular radar sensor 10, a two-dimensional spectrum is calculated by a 2-dimensional Fourier transformation, for example a 2D FFT, of baseband signals of the received response signals. The transformation is carried out in a first dimension per ramp 40 and in a second dimension via the ramp index j of the ramp sequence in question. The sizes of the respective transformations, i.e. their respective numbers of bins (sampling points or support points) are preferably uniform for all spectra for the first dimension and for the second dimension in each case.

Due to the relative velocity v of the radar target 18 and the time offset Tab, Tac, Tad (FIG. 2) between the partial measurements corresponding to the individual ramp sequences, a phase difference occurs between the partial measurements. The phase difference between the partial measurements is obtained as the phase difference between the complex amplitudes (spectral values) of a peak occurring at the same position in the two-dimensional spectra. However, due to the relatively large time offset Tab, Tac, Tad between the corresponding ramps 40 of the respective ramp sequences, the determination of the phase differences between the partial measurements does not allow any direct conclusions to be drawn about the relative velocity v. This is because, due to the periodicity of the phases, an individual phase difference results in ambiguity for the associated value of the relative velocity v. In the example, the different sensors 10 have the same time offsets Tab, Tac, Tad. In a variant of the example, the time offsets Tab, Tac, Tad of the different sensors are selected differently. This results in different ambiguities of the relative velocity v for the respective radar sensors, which simplifies the resolution of the ambiguities.

From the two-dimensional complex spectra obtained, in each case a power spectrum is calculated by forming the square of the absolute value of the respective spectral values, and the power spectra are combined point-by-point by summation or averaging to form an integrated two-dimensional power spectrum.

The position of a peak corresponding to a radar target 18 in the power spectrum, which is indicated below as bin k, 1, corresponds to the position of the peak in the individual spectra. From the first dimension, corresponding to the bin k of the position of the peak, according to the FMCW equation k=2/c(dF+f₀vT), a linear relationship between the relative velocity v and the distance d of the radar target is obtained. Here, c is the speed of light, F is the ramp deviation, T is the ramp duration of a single ramp and f₀ is the average transmission frequency. If the frequency difference of ramps which follow on from one another of a sequence is zero, the peak position in the second dimension 1 contains only information about the relative velocity v of the radar target.

There is a linear relationship between the relative velocity v and the distance d. In the example shown, due to a relatively large time interval Tr2r, the information about the relative velocity of the radar target obtained from the sampling of the Doppler frequency is subject to ambiguity, since the Doppler frequency resulting from the relative movement with the velocity v is not clearly sampled due to the relatively large time intervals Tr2r of the particular ramp sequence. In addition to the linear relationship between the relative velocity v and the distance d, which results according to the frequency bin k, periodic values of the relative velocity v result from the frequency bin 1, so that possible value pairs (v, d) of relative velocity and distance of the detected radar target 18 are obtained.

The ambiguity of the ascertained velocity v is now resolved as explained below. For evaluating the measured phase difference, a control vector a(v) of an ideal measurement is calculated according to the relative velocity v. A measurement vector aₘ is defined accordingly, wherein instead of the expected, velocity-dependent complex values, the complex amplitudes (spectral values) at the position of the peak of the calculated two-dimensional spectra of the partial measurements are used as components of the vector. Based on the measurement vector and the control vector, a normalized likelihood function in the form of a relative velocity spectrum S(v) is defined. Maxima of the likelihood function correspond to the most probable values of the parameter v. Taken alone, the relative velocity spectrum S(v) can be ambiguous; a maximum at the maximum value 1 corresponds in each case to an optimal match of the ideal phase shifts resulting for the relative velocity v in question with the measured phase shift according to the measurement vector. However, an evaluation of the function S(v) is only required at the points corresponding to the periodic values of the relative velocity v which were obtained from the evaluations according to the position of the peak in the bins (k, l). A maximum match obtained here at a relative velocity v, where the function S(v) assumes the expected maximum value of 1, corresponds to the actual value of the relative velocity v.

The ambiguity resulting from the position of the peak can thus be resolved by the additional information from the phase relationship. Based on the linear relationship, an estimated value for the distance d corresponding to the selected estimated value for the relative velocity v is determined.

The time signals (baseband signals) corresponding to the different sequences of ramps are initially processed separately. The detection of a radar target takes place in the power spectrum obtained by non-coherent integration. Based on the detection and the complex amplitudes at the position of the peak, the ambiguity of the velocity v is then resolved.

The above statements relate to a conventional radar evaluation without code multiplexing for the various transmission antenna elements 14-1, 14-2, . . . . The phase coding of the transmission signals for the individual transmission antenna elements with a harmonic code also leads to additional ambiguities, which must also be resolved. In the case of code multiplexing, a transmitter with a corresponding code assignment experiences a shift of the peaks in the second dimension of the spectrum. This results in NTX peaks in the spectrum for a number of NTX transmitters. This additional ambiguity must also be resolved.

Due to the harmonic phase modulation of the transmission signals, a transmitter shift is equivalent to a bin shift in the Doppler dimension. This bin shift is equivalent to a modified estimation of the relative velocities v in question.

In a preferred embodiment with harmonic codes in the case of NTX transmitters (NTX transmission antenna elements per radar sensor 10), the transmitter offset corresponds to an l-bin offset of Δ=N_slow/NTX. The velocity offset is therefore continued equivalently to undersampling in the Doppler domain or, in other words, the distances between the evaluated relative velocities across the transmitters are “filled in.” For determining the relative velocity of the radar object, these additional ambiguities due to code multiplexing must now also be evaluated.

The described method can also be extended to carry out a radar measurement with a plurality of reception channels of a radar sensor. For each reception channel, a measurement vector a_m(n) is then obtained for the n-th channel.

In FIG. 3, a step 64 comprises a step 64-1 of resolving the velocity ambiguities and a step 64-2 of target detection. The resolution of velocity ambiguities can occur prior to or after target detection. The procedure is the same as for the code multiplexing method in US 2019/0353770 A1 or DE 10 2017 200 317 A1 and explained above.

According to a variant 1 of the method of FIG. 3, step 64 is followed by a step 66 of compensating for the time offsets between the bistatic and monostatic signals. For this purpose, a phase difference between the respective radar sensors 10 is taken into account, which depends on the relative velocity v of the radar target 18. The particular phase difference Δφ₁₂ between two radar sensors 10-1, 10-2 can be determined, for example, according to the following formula:

$${Δφ}_{12} = 2 π \frac{2}{C} {\int }_{0} {T}_{12} v$$

Here, c corresponds to the speed of light, f₀ corresponds to the center frequency of the chirp sequence modulation (ramp), T₁₂ corresponds to the time offset between the ramp sequences of the two sensors (or between the monostatic and the bistatic response received in one sensor) and v corresponds to the relative velocity of the target which was determined in the individual sensor. If the target is far enough away (far field), then each of the two individual sensors measures a (nearly) identical velocity. At close range, the two measured velocities of the sensors can differ. For the bistatic signal response, the mean value of the two velocities measured (by the respective radar sensors) must be taken into account.

The particular phase difference Δφ₁₂ between two of the radar sensors 10 for a radar target 18 is thus ascertained based on the determined estimated value for the relative velocity v of the radar target 18 and based on a particular time offset T₁₂ (or T₁₃) within a block 48 between the ramp groups 44 of the respective radar sensors 10.

The compensation for the time offsets is carried out, for example, by applying a phase correction to the complex amplitudes of the bistatic response signal, e.g. by means of multiplication of exp(−1.0i Δφ₁₂). Subsequently, the complex amplitudes of the monostatic response signals and the bistatic response signals only contain the angle information, and the angle of the radar target can be determined using conventional methods for angle estimation (e.g., deterministic maximum likelihood estimator, DML). The complex amplitudes are compared e.g. with a measured antenna pattern, and the estimated angle is the angular position at which the match is best.

For angle estimation, in a step 68, digital beamforming for a radar target is performed over the transmission channels allocated to the transmitter antenna elements 14 and/or over the reception channels allocated to the reception antenna elements 16 by all radar sensors 10 or a subset of the radar sensors 10. Step 68 is thus a step of coherent MIMO beamforming over the transmission and reception channels of all sensors 10 or a subset.

According to a variant 2 of the method of FIG. 3, the performance of the digital beamforming for a radar target is divided into two sub-steps. In a step 68-1, coherent MIMO beamforming is carried out for each sensor 10. In this first sub-step, digital beamforming for the radar target is performed over the transmission channels allocated to the transmission antenna elements and/or over the reception channels allocated to the reception antenna elements of a particular radar sensor 10. At this point, after step 68-1, an output and/or further processing of the monostatic results can be carried out in a step 69.

Subsequently, step 66 of compensating for the time offsets between the bistatic and monostatic signals is performed. After step 66, a step 68-2 is carried out, in which a coherent combination of the partial beamformings of the individual sensors is performed. The digital beamformings of the respective radar sensors 10 are combined taking into account the phase differences between the radar sensors 10 which are dependent on the relative velocity v of the radar target 18.

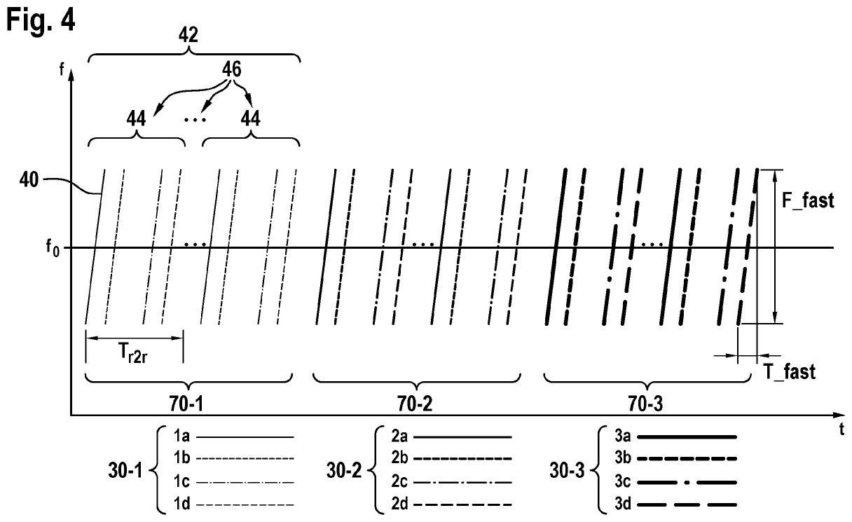

FIG. 4 schematically shows a diagram for the frequency f of transmission signals 30-1, 30-2, 30-3 of three radar sensors 10 of a cooperative radar sensor network 100, which can in principle correspond to the structure of FIG. 1, but comprises three FMCW radar sensors 10. The transmission signals 30-1, 30-2, 30-3 of the three radar sensors 10 are again represented by different line thicknesses.

In each radar sensor 10, the corresponding ramp-like frequency-modulated transmission signal 30-1, 30-2 or 30-3 is generated. Each transmission signal 30-1, 30-2, 30-3 comprises a plurality of ramp sequences for each radar sensor 10, in the example shown four ramp sequences 1a, 1b, 1c, 1d or 2a, 2b, 2c, 2d or 3a, 3b, 3c, 3d. The respective ramp sequences are represented by different line types.

In FIG. 4, only the first and last ramps 40 of each ramp sequence are shown. The ramps 40 which follow on from one another belonging to the same transmission signal 30-1, 30-2, 30-3 together form a section 42 of the transmission signal 30-1, 30-2 or 30-3 in question. The transmission signal 30-1, 30-2 or 30-3 frequency-modulated according to the ramp 40 is, for each transmission antenna element 14 of the radar sensor in question, phase-modulated with a harmonic code and transmitted by the transmission antenna element 14.

FIG. 4 shows an example of a radar modulation scheme #2 for three radar sensors 10, with in each case a plurality of, e.g. four, transmission antenna elements 14 which are simultaneously active by means of Doppler division multiplexing (DDM) with harmonic codes.

In this example, instead of the temporal nesting of the transmission operation of the sensors in FIG. 2 and FIG. 3, a sequential transmission operation of the individual sensors is carried out, wherein all sensors receive continuously.

The ramp-like frequency-modulated transmission signal 30-1, 30-2 or 30-3 of a respective one of the radar sensors 10 has a plurality of temporally nested ramp sequences. For example, the transmission signal 30-1 of the first radar sensor 10 has the four temporally nested ramp sequences 1a, 1b, 1c and 1d. Within the particular ramp sequence, the ramps follow on from one another in a time-offset manner with a predetermined time interval Tᵣ₂ᵣ. A measurement cycle of the radar sensors 10, of which only the first ramp and the last ramp of each ramp sequence are shown in FIG. 4, comprises sections 42 which follow on from one another temporally, which in each case are allocated to one of the radar sensors 10 and thus to the corresponding transmission signal 30-1, 30-2 or 30-3 of the radar sensor 10 in question. Each section 42 comprises all ramps 40 of the ramp sequences of the transmission signal exclusively from the radar sensor 10 allocated to this section 42. Thus, the first section 42, identified in FIG. 4, comprises exclusively ramps 40 exclusively from the first radar sensor 10, wherein the ramps belong to its transmission signal 30-1.

For the particular transmission signal 30-1, 30-2, 30-3, the term ramp group again refers to a group of those ramps of the ramp sequences of the transmission signal that have an identical ramp index. For example, the transmission signal 30-1 of the first radar sensor 10 comprises ramp groups 44, which in each case comprise a ramp 40 from the ramp sequences 1a, 1b, 1c and 1d. In radar modulation scheme #2 as well, the transmission signal 30-1, 30-2, 30-3 of the particular radar sensor 10 thus comprises a sequence 46 of ramp groups 44 arranged temporally one after the other, wherein each ramp group 44 comprises a ramp 40 from each of the ramp sequences 1a, 1b, 1c, 1d of the radar sensor 10. Pauses occur between some of the ramps of a particular ramp group 44.

At the same time, the measurement cycle of the plurality of radar sensors 10 is divided into sub-cycles 70-1, 70-2, 70-3 which follow on from one another temporally. Each sub-cycle 70-1, 70-2, 70-3 is allocated to one of the radar sensors 10 and comprises the ramp groups 44 exclusively from the allocated radar sensor 10. The sub-cycle 70-1 of the first radar sensor 10 comprises the transmission signal of the first radar sensor 10. Accordingly, the sub-cycles 70-2 and 70-3 in each case comprise the transmission signal of the corresponding second radar sensor 10 or third radar sensor 10.

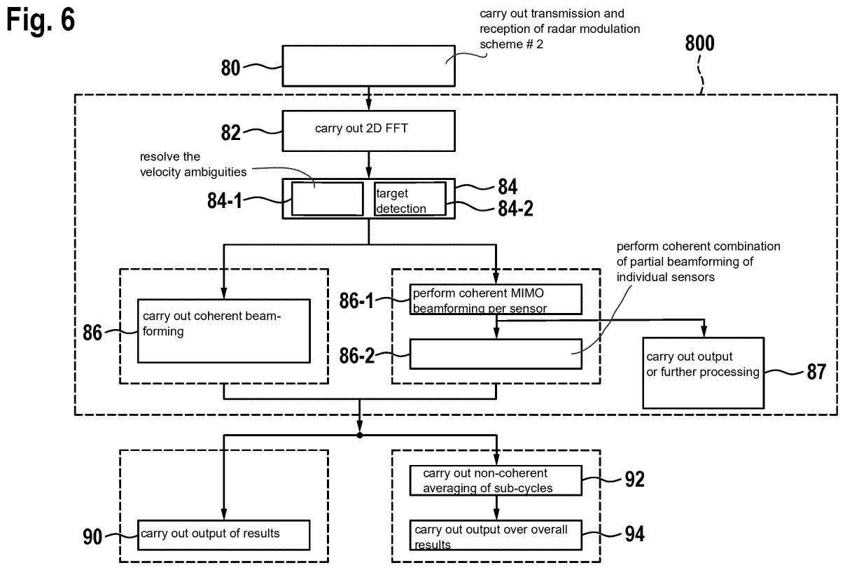

The further evaluation is carried out according to the method explained below in FIG. 6. The processing is initially carried out individually for each sub-cycle 70, wherein differences from the method of FIG. 3 are explained in particular below.

In a step 80, the transmission and reception of radar modulation scheme #2 is carried out. Step 80 corresponds to the step 60 of FIG. 3 with the difference that radar modulation scheme #2 is used, for example, according to FIG. 4.

For each sub-cycle 70-1, 70-2, 70-3, processing is then carried out in a subsequent section 800 of the method as follows.

In a step 82, a 2D FFT of the individual ramp sequences is carried out in each of the sensors. In this respect, step 82 corresponds to step 62 of FIG. 3. In the example, the different sensors 10 or transmission signals 30-1, 30-2, 30-3 have the same time intervals Tr2r with which the ramps within the particular ramp sequence follow one another, and the same ramp durations T_fast. In variants of the example, the time intervals Tr2r and/or the ramp durations T_fast of the different sensors 10 or transmission signals 30-1, 30-2, 30-3 are selected differently. This then results in different velocity ambiguities in the spectra.

In a step 84, the resolution of the velocity ambiguities is carried out prior to or after the target detection. Step 84 corresponds to step 64 of FIG. 3 and can in particular comprise step 84-1 of resolving the velocity ambiguities which corresponds to step 64-1, as well as step 84-2 of target detection which corresponds to step 64-2.

When the individual sensors 10 transmit sequentially, the accuracy of the velocity measurement of the individual sensor is, as a rule, not sufficient in order to enable coherent processing of the transmission signals across sensors. Instead, a separate evaluation of the so-called “sub-cycles” is carried out, wherein the transmission signals of the particular active sensor and the reception signals (RX) of all sensors can be evaluated.

In a variant 1 of the section 800, in a step 86, coherent MIMO beamforming is carried out over all transmission and reception channels of the current sub-cycle. Thus, the performance of digital beamforming is carried out over the transmission channels allocated to the transmission antenna elements 14 and/or over the reception channels allocated to the reception antenna elements 16 of the radar sensor 10 in question for a radar target 18 and for the sub-cycle 70 in question. In particular, in step 86, an angle estimation for the radar target 18 is ascertained, wherein ascertaining the angle estimation for the radar target comprises performing digital beamforming for the radar target.

In a variant 2 of the section 800, the performance of the digital beamforming for the sub-cycle is divided into a sub-step 86-1 of coherent MIMO beamforming per sensor and a sub-step 86-2 of a coherent combination of the partial beamforming of the individual sensors. After step 86-1, in a step 87, an output and/or further processing of the monostatic results can be carried out. The combining of the partial beamformings in sub-step 86-2 can in turn be carried out taking into account the time offsets between the signals of the sensors 10, i.e., it can comprise compensation for the time offsets.

A second section of the method can follow the first section 800.

According to a variant of the method, an output of the results for each sub-cycle is carried out in a step 90. The sequential transmission operation of the individual sensors 10 results in an update rate of the detected targets that is increased by the number of sensors, since the processing takes place in each “sub-cycle.”

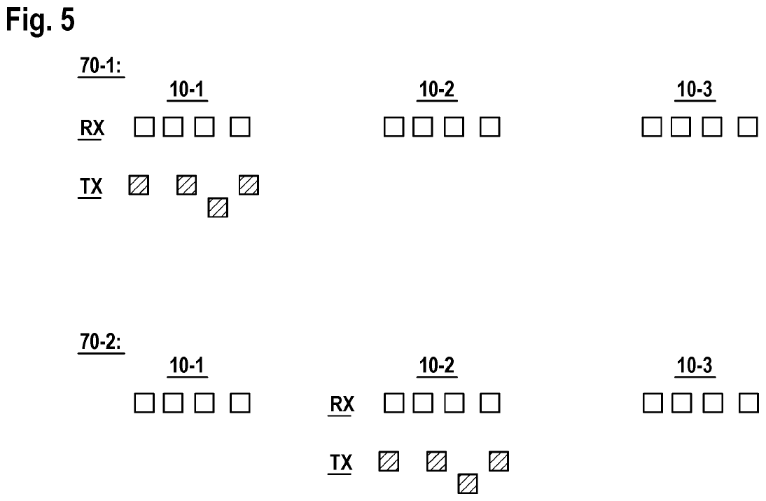

Simultaneously, due to the different activations of the transmitters (TX), i.e. transmitter antenna elements 14, in the sub-cycles 70, different virtual antenna arrangements with different ambiguity properties in the angle estimation are obtained. This is illustrated schematically in FIG. 5.

FIG. 5 shows, in the upper part, an arrangement of the actively transmitting transmission antenna element arrangement TX of a first radar sensor 10 and the three receiving reception antenna element arrays RX of the three radar sensors 10, corresponding to the sub-cycle 70-1. This results in a corresponding virtual antenna arrangement.

In the lower part, FIG. 5 shows an arrangement of the actively transmitting transmission antenna element arrangement TX of the second radar sensor 10 and the three receiving reception antenna element arrays RX of the three radar sensors 10, corresponding to the sub-cycle 70-2. This results in a corresponding, different virtual antenna arrangement.

The sensors 10 can also comprise different array arrangements TX and/or RX, e.g. with different distances between the antenna elements.

According to an alternative variant or in addition to the processing with the step 90, the method according to a variant can comprise the steps 92 and 94, which are explained below.

In a step 92, non-coherent averaging of the sub-cycles 70 is carried out. The non-coherent averaging of the sub-cycles can be carried out at the spectral level prior to the detection of the targets, or it can be carried out by averaging the angular spectra after target detection. In the first case, the range-Doppler spectra are averaged in terms of performance in order to subsequently achieve improved detection performance. However, the complex amplitudes of the non-averaged spectra are subsequently required again in order to determine individual angle estimations/angular spectra for each of the sub-cycles. In the second case, detection is first carried out in the individual spectrum and subsequently an angular spectrum is calculated for each sub-cycle 70 (e.g., with the aid of a DML estimator). Subsequently, the angular spectra of the sub-cycles can be averaged non-coherently. The method thus comprises, in step 92, combining the digital beamformings of the radar sensors by non-coherently averaging the digital beamformings of the radar sensors and the relevant sub-cycles or by averaging angular spectra, obtained by the digital beamformings, of the radar target of the radar sensors and relevant sub-cycles. In step 94, an output of the overall results is carried out. Thus, non-coherent averaging can be carried out at the spectral level prior to the detection of targets, or by averaging the angular spectra after target detection.

In the examples of FIG. 2 and FIG. 4, the ramp sequences of the individual transmission signals 30-1, 30-2, 30-3 in each case have identical parameters such as ramp duration T_fast, ramp deviation F_fast, ramp center frequency f₀ and thus the identical frequency curve. The following parameters are shown as examples in FIG. 2: Ramp duration T_fast, ramp deviation F_fast, ramp center frequency f₀. Here, the ramp center frequency corresponds to the average transmission frequency f₀. In other examples, the ramp center frequency of the ramps can also increase or decrease during the transmission of a ramp sequence. For example, ramps which follow on from one another within a ramp sequence can have the same difference in ramp center frequencies. For a time T_slow of a ramp sequence (corresponding to a duration of the measurement cycle) and a frequency F_slow of the ramp center frequencies during the entire ramp sequence, the ramp slope s slow of the ramp center frequencies can be described by s slow=F_slow/T_slow.

In particular, ramps 40 with the same ramp index j in the nested ramp sequences can in each case have the same ramp slope F_fast/T_fast.

1-15. (canceled)

16. A method for determining a relative velocity of a radar target, comprising the following steps:
transmitting phase-modulated transmission signals using a plurality of transmission antenna elements of each of a plurality of radar sensors, wherein a ramp-like frequency-modulated transmission signal of each respective one of the radar sensors is generated which has a plurality of temporally nested sequences of ramps, wherein the ramps within the each sequence follow one another in a time-offset manner with a predetermined time interval, wherein a phase of the generated ramp-like frequency-modulated transmission signal, for each transmission antenna element of a radar sensor, is phase-modulated with a code, and wherein a measurement cycle of the plurality of radar sensors includes sections which follow on from one another temporally, which each of the sections is allocated to one of the radar sensors and includes one ramp or a plurality of ramps of the transmission signal exclusively from the radar sensor allocated to the section;
receiving response signals to the transmitted phase-modulated transmission signals;
calculating a two-dimensional spectrum for each sequence of the transmission signal of a respective radar sensor by a two-dimensional Fourier transformation of baseband signals of the received response signals, wherein the transformation is carried out in a first dimension per ramp and in a second dimension via a ramp index of the sequence of ramps;
ascertaining values for relative velocities of a radar target that are periodic with a predetermined velocity period, based on a peak in one of the calculated two-dimensional spectra; and
determining an estimated value for the relative velocity of the radar target based on matches in phase relationship between values of the two-dimensional spectra at identical positions with expected phase relationships for a plurality of the ascertained values of relative velocities.

17. The method according to claim 16, wherein:
the transmission signal of each respective radar sensor includes a sequence of ramp groups arranged temporally one after the other, wherein each ramp group includes a ramp from each of the sequences of the ramps of the transmission signal of the respective radar sensor,
a measurement cycle of the plurality of radar sensors includes blocks which follow on from one another temporally, wherein each block includes a ramp group from each of the radar sensors.

18. The method according to claim 17, wherein, in each block, the ramps of one ramp group of the block are temporally nested with the ramps of each of the other ramp groups of the block.

19. The method according to claim 16, wherein the transmission signals of the plurality of radar sensors have different time offsets between their sequences of the ramps.

20. The method according to claim 16, further comprising:
performing digital beamforming for a radar target over transmission channels allocated to the transmission antenna elements and/or over reception channels allocated to reception antenna elements of at least two of the plurality of radar sensors, wherein, when performing the digital beamforming, phase differences between the radar sensors which are dependent on the relative velocity of the radar target are taken into account, wherein a respective phase difference between two of the radar sensors for a radar target is ascertained based on at least one estimated value for the relative velocity of the radar target and based on a time offset between the ramp groups of the two radar sensors.

21. The method according to claim 20, further comprising:
ascertaining an angle estimation for the radar target, wherein ascertaining the angle estimation for the radar target includes performing digital beamforming for the radar target.

22. The method according to claim 20, wherein performing the digital beamforming for a radar target includes a first sub-step in which digital beamforming for the radar target is performed over transmission channels allocated to the transmission antenna elements and/or over reception channels allocated to the reception antenna elements of each respective one of the at least two of the plurality of radar sensors, and a second sub-step in which the digital beamformings of the respective at least two radar sensors are combined, taking into account the phase differences between the radar sensors which are dependent on the relative velocity of the radar target.

23. The method according to claim 16, wherein:
the transmission signal of each respective radar sensor includes a sequence of ramp groups arranged temporally one after the other, wherein each ramp group includes a ramp from each of the sequences of the ramps of the transmission signal of the respective radar sensor,
each measurement cycle of the plurality of radar sensors includes sub-cycles which follow on from one another temporally, wherein each sub-cycle is allocated to one of the radar sensors and includes the ramp groups exclusively from the allocated radar sensor.

24. The method according to claim 23, wherein the transmission signals of the plurality of radar sensors have different time intervals with which the ramps within each respective sequence of the ramps follow one another with a time offset, and/or different ramp durations.

25. The method according to claim 23, further comprising:
performing digital beamforming over transmission channels allocated to the transmission antenna elements and/or over reception channels allocated to reception antenna elements of a respective one of the plurality of radar sensors for a radar target and for a relevant sub-cycle.

26. The method according to claim 25, further comprising: ascertaining an angle estimation for the radar target, wherein the ascertaining of the angle estimation for the radar target includes performing digital beamforming for the radar target.

27. The method according to claim 25, wherein the digital beamforming is performed over transmission channels allocated to the transmission antenna elements and/or over reception channels allocated to the reception antenna elements of each respective one of at least two of the plurality of radar sensors for a radar target and for a respective relevant sub-cycle, and wherein the method further comprises:
combining the digital beamformings of the at least two radar sensors by non-coherently averaging the digital beamformings of the at least two radar sensors and relevant sub-cycles or by averaging angular spectra, obtained by the digital beamformings, of the radar target of the at least two radar sensors and the relevant sub-cycles.

28. The method according to claim 16, wherein the receiving of the response signals to the transmitted phase-modulated transmission signals includes: at least response signals to the phase-modulated transmission signal transmitted by the transmission antenna elements of a respective radar sensor are received using at least one reception antenna element of the respective radar sensor and response signals are received using at least one reception antenna element of another one of the plurality of radar sensors.

29. A radar sensor network for determining a relative velocity of a radar target, comprising:
a plurality of radar sensors; and
at least one evaluation unit;
wherein each of the plurality of radar sensors includes:
a plurality of transmission antenna elements,
a signal generating device configured to generate a ramp-like frequency-modulated transmission signal and to provide the transmission signal to the transmission antenna elements, wherein the transmission signal has a plurality of temporally nested sequences of ramps, wherein the ramps within each respective sequence follow one another in a time-offset manner with a predetermined time interval, wherein a phase of the generated ramp-like frequency-modulated transmission signal is, for each transmission antenna element of a radar sensor, phase-modulated with a code, and
at least one reception antenna element configured to receive a response signal to the transmitted phase-modulated transmission signals;
wherein the evaluation unit is configured to ascertain values for relative velocities of a radar target that are periodic with a predetermined velocity period, based on a peak in one of the two-dimensional spectra calculated for each sequence of the transmission signal of a respective radar sensor, and to determine an estimated value for the relative velocity of the radar target based on matches in phase relationships between values of the two-dimensional spectra at identical positions with expected phase relationships for a plurality of the ascertained values of relative velocities.

30. The radar sensor network according to claim 29, wherein each of the plurality of radar sensors includes a plurality of reception antenna elements.
